(19) United States
(12) Patent Application Publication
(10) Pub. No.: US 2009/0119099 A1
(43) Pub. Date: May 7, 2009

(54) System and method for automobile noise suppression

(75) Inventors: Chun-Min Lee, Taoyuan County (TW); Ming-Ta Wei, Taoyuan County (TW); Yu-Chi Hsu, Taoyuan County (TW)

Correspondence Address: GROSSMAN, TUCKER, PERREAULT & PFLEGER, PLLC, 55 SOUTH COMMERICAL STREET, MANCHESTER, NH, 03101, US

(73) Assignee: HTC CORPORATION, Taoyuan City (TW)

(21) Appl. No.: 12/265,164

(22) Filed: Nov. 5, 2008

(30) Foreign Application Priority Data
Nov. 6, 2007 (TW) 096141852

(51) Int. Cl. G10L 15/20; H04B 15/00; G10L 21/02

(52) U.S. Cl. 704/226; 381/94.1; 704/233; 704/E15.039; 704/E21.002

(57) ABSTRACT

A system and a method for automobile noise suppression in an automobile are provided. The system comprises a processor and a noise suppression device. The noise suppression device is configured for receiving a voice signal, which includes a speech signal and a noise signal. The processor is configured for determining an adjusting parameter set according to an automobile speed signal corresponding to a speed of the automobile. The noise suppression device can suppress the noise signal according to the adjusting parameter set, whereby enhancing the voice quality.

### CROSS-REFERENCES TO RELATED APPLICATIONS

This application claims priority of Taiwan Patent Application No. 096141852 filed on Nov. 6, 2007, the entirety of which is incorporated by reference herein.

### BACKGROUND OF THE INVENTION

1. Field of the Invention

The present invention relates to a system and a method for noise suppression, and more particularly, to a system and a method for automobile noise suppression.

2. Descriptions of the Related Art

At present, the automobiles commercially available are usually equipped with multi-function automobile computer systems. In conventional automobile computer systems, besides the Global Positioning System (GPS) device and multimedia player modules and the like, an important module, namely, a mobile communication module incorporating a hands-free feature, is provided to facilitate speech communication of the automobile drivers or other passengers at any time during the travel. However, during speech communication, in addition to the speech of the users, the voice receiving device of the mobile communication module tends to also receive and record the ambient noise, thereby compromising the communication quality.

In particular, the noises that arise during the driving process mainly originate from the so-called engine and wind noise. The wind noise is attributable to the many metal sheet slits formed on the automobile body itself, for example, the slits formed around the automobile doors and the engine cover. As the automobile travels, the ambient air will flow with respect to the automobile and wind noise will occur while the air flows through the slits. Obviously, the faster the automobile travels, the greater the wind noise occurs. Consequently, it is important to effectively suppress the engine noise and wind noise and prevent the interference of such noise on speech communication of the driver or passenger(s) in the automobile.

One conventional method is to process the received voice through a Digital Signal Processing (DSP) algorithm. More specifically, some noise suppression parameters are employed to determine a Signal-to-Noise Ratio (SNR) for suppressing the noise portion of the voice. Unfortunately, this conventional method selects only one set of fixed parameters to suppress the noise. As a result, when the automobile speed increases with higher noises, the single set of fixed parameters may be inadequate to effectively suppress the noises. In contrast, when the automobile speed decreases, the selected parameters may make an attempt to suppress the noise signals of relatively smaller magnitudes, which may affect the speech portion unexpectedly, thereby compromising the communication quality.

According to the above descriptions, the conventional noise suppression method employed in the automobile computer system is unable to flexibly adjust the parameters used to determine the SNR according to the magnitude of the noise, thus resulting in a poor noise suppression effect. As a result, it is highly desirable in the art to provide a solution capable of enhancing the communication speech quality by effectively suppressing the noise arising in the running automobile.

### SUMMARY OF THE INVENTION

One objective of this invention is to provide a system and a method for automobile noise suppression, which are able to suppress the noise component of the voice by dynamically determining the adjusting parameters for the SNR adjustment, thus yielding more clear speech and improving the quality of speech communication or voice recording in the running automobile.

Another objective of this invention is to provide a system and a method for automobile noise suppression in an automobile computer system, which utilizes the actual driving speed of the automobile as a reference to determine the noise portion and further select the adjusting parameters for the SNR adjustment. The noise portion of the voice is suppressed according to the adjusting parameters, thereby minimizing the interference to the speech component.

To this end, a method for automobile noise suppression according to the invention comprises the following steps: receiving a voice to generate a voice signal, which includes a speech signal and a noise signal; determining an adjusting parameter set according to an automobile speed signal corresponding to a speed of the automobile; and suppressing the noise signal according to the adjusting parameter set.

This invention further discloses a system for automobile noise suppression, which comprises a speed sensing device, a processor and a noise suppression device. The speed sensing device is configured for generating an automobile speed signal. The processor is configured for receiving the automobile speed signal and determining an adjusting parameter set according to the automobile speed signal. The noise suppression device is configured for receiving a voice signal which includes a speech signal and a noise signal. The noise suppression device suppresses the noise signal and generates an adjusted voice signal according to the adjusting parameter set.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of the first embodiment in accordance with this invention; and

FIG. 2 is a flow chart of a method in accordance with the second embodiment of this invention.

### DESCRIPTION OF THE PREFERRED EMBODIMENT

In the following description, this invention will be explained with reference to embodiments thereof. However, these embodiments are not intended to limit this invention to any specific environment, applications or particular implementations described in these embodiments. Therefore, the description of these embodiments is only for purposes of illustration rather than limitation. In the following embodiments and the attached drawings, elements unrelated to this invention are omitted from depiction.

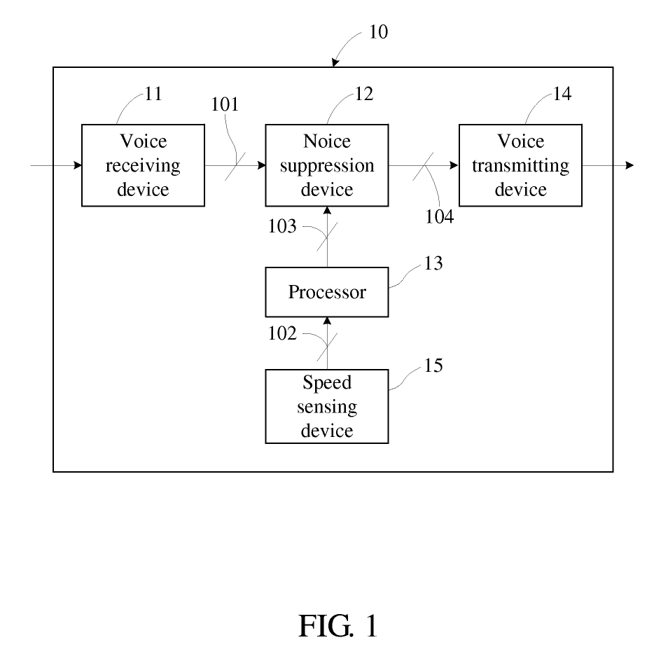

FIG. 1 depicts the first embodiment of this invention, which is a system 10 for automobile noise suppression in an automobile. The system 10 comprises a voice receiving device 11, a noise suppression device 12, a processor 13, a voice transmitting device 14 and a speed sensing device 15. The operations of the system 10 are described as follows.

As the automobile travels, the voice receiving device 11 (e.g., a microphone) receives a voice to generate a voice signal 101 and transmits the voice signal 101 to the noise suppression device 12. Since the voice signal 101 includes a speech signal and a noise signal, that is, the voice signal 101 includes both the speech signal from the driver and the noise signal originating from the ambient environment (e.g., the engine noise and wind noise), the noise suppression device 12 proceeds to suppress the noise signal after receiving the voice signal 101 to prevent the speech signal from being interfered by the noise signal.

In addition, the speed sensing device 15 generates an automobile speed signal 102 corresponding to a speed of the automobile. The processor 13 receives the automobile speed signal 102 and then determines an adjusting parameter set 103 according to the automobile speed signal 102. Specifically, the automobile speed signal 102 is substantially corresponding to the speed of the automobile, namely, the speed at which the automobile is traveling at that time. In one embodiment of the present invention, the speed sensing device 15 may be an odometer that pre-exists in the automobile. The processor 13 receives the automobile speed signal 102 from the odometer through a controller area network bus (CAN Bus); however, this invention is not limited thereto, and other devices capable of sensing the automobile speed may also be employed to achieve the same goal. The automobile CAN Bus is provided in the automobile computer system and may be employed to collect and provide the information on various devices of the automobile. For example, the automobile speed signal in this embodiment is the speed signal of the automobile itself.

Thereafter, the processor 13 determines the adjusting parameter set 103, which is corresponding to the automobile speed signal 102, by checking a speed-to-parameter lookup table. In this embodiment, the adjusting parameter set 103 is selected from a group consisting of a noise attenuation slop, a threshold of operating noise attenuation and a maximum noise attenuation level. The three adjusting parameters are also parameters used most commonly to adjust the SNR. However, other parameters applicable to noise suppression may also be utilized in this invention, added or replaced by those of ordinary skill in the art and, thus, are not to be limited herein.

The speed-to-parameter lookup table may be generated in advance through a test procedure. In particular, the magnitude of noise arising in the automobile at different traveling speeds of the automobile may be tested to record the applicable adjusting parameter set 103, which are corresponding to the different traveling speeds, in the speed-to-parameter lookup table. Also, the test may be carried out on the noise suppression chips of various specifications and automobiles of various types to generate the respective speed-to-parameter lookup tables for these automobiles, thereby making the adjusting parameter set 103 more accurate.

The processor 13 transmits the adjusting parameter set 103 selected according to the automobile speed to the noise suppression device 12. The noise suppression device 12, in turn, suppresses the noise signal according to the adjusting parameter set 103 and generates an adjusted voice signal 104 by combining the speech signal with the suppressed noise signal. In particular, the noise suppression device 12 determines the adjusting parameters for the SNR adjustment according to the parameters contained in the adjusting parameter set 103, so as to suppress the noise signal of the voice signal 101. Hence, in the adjusted voice signal 104, the speech signal from the user will become relatively clearer.

For example, if an automobile travels initially at a speed of 50 km/h, the processor 13 determines an adjusting parameter set corresponding to the speed of 50 km/h by checking the speed-to-parameter lookup table, so as to adjust the SNR to 50 dB. Once the automobile is accelerated to travel at a speed of 100 km/h to result in louder ambient noise, the processor 13 will determine another adjusting parameter set corresponding to the speed of 100 km/h by checking the speed-to-parameter lookup table, so as to adjust the SNR to 80 dB, thereby enhancing the noise suppression effect.

Finally, the voice transmitting device 14 receives the adjusted voice signal 104 from the noise suppression device 12 and transmits the adjusted voice signal 104. In this embodiment, the voice transmitting device 14 is a radio frequency (RF) module for transmitting voice signal and may be built into the computer system. In other embodiments, the adjusted voice signal 104 may also be transmitted to the processor 13 for other purposes, such as for voice recording.

The system for automobile noise suppression according to this embodiment may determine the adjusting parameter set 103 for the SNR adjustment according to the automobile speed signal 102 received by the processor 13. In other words, the system 10 for automobile noise suppression can dynamically adjusts the parameters for the SNR adjustment according to the automobile speed so as to suppress the noise portion of the voice, thereby improving the quality of speech communication or voice recording.

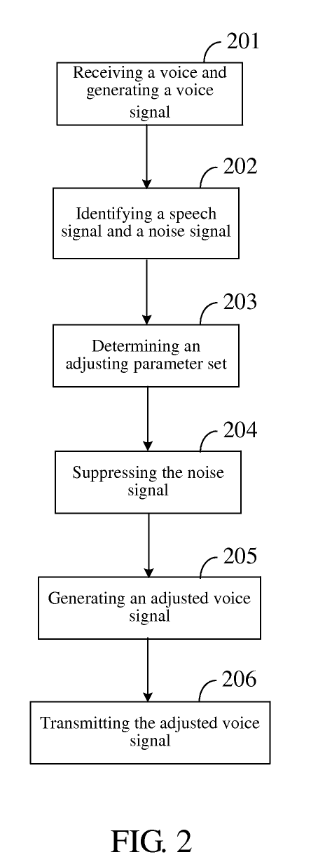

The second embodiment of this invention is a method for automobile noise suppression in the aforesaid system 10. In reference to FIG. 2, this method begins with step 201. When a user is in communication and sends out a speech, the voice receiving device 11 (e.g., a microphone) is utilized to receive a voice including the speech and generate a voice signal 101, which is corresponding to the voice and then transmitted to the noise suppression device 12. Then, step 202 is executed where the noise suppression device 12 identifies a speech signal and a noise signal from the voice signal 101 for subsequent noise suppression processing.

Next, step 203 is executed to determine the adjusting parameter set 103 according to the automobile speed signal 102. More particularly, this step is to receive the automobile speed signal 102 from an odometer through a CAN Bus and determine the adjusting parameter set 103 corresponding to the automobile speed signal 102 by checking the predetermined speed-to-parameter lookup table.

Specifically, the automobile speed signal 102 received by the processor 13 through the CAN Bus is substantially corresponding to a speed of an automobile. The adjusting parameter set 103 as determined according to the automobile speed signal 102 is used for adjusting the SNR. Likewise, in this embodiment, the adjusting parameter set 103 is selected from a group consisting of a noise attenuation slop, a threshold of operating noise attenuation and a maximum noise attenuation level. Additionally, the speed-to-parameter lookup table is generated in the same manner as that in the first embodiment and this will not be further described herein.

Next, step 204 is executed to suppress the noise signal according to the adjusting parameter set 103. That is, the processor 13 transmits the adjusting parameter set 103 to the noise suppression device 12 which, according to the adjusting parameter set 103, then adjusts the parameter for the SNR adjustment to suppress the noise signal. Subsequently, step 205 is executed where the noise suppression device 12 generates an adjusted voice signal 104. Next, step 206 is executed to transmit the adjusted voice signal 104. The adjusted voice signal 104 may be transmitted to an RF module for transmitting voice signal, or to the processor 13 for other purposes such as voice recording.

According to the method for automobile noise suppression in this embodiment, the adjusting parameter set 103 for the SNR adjustment is determined according to the automobile speed signal 102. In this way, when the automobile speed is increased or decreased resulting in an increase or decrease in the ambient noise, the adjusting parameter set 103 can be adjusted dynamically to adjust the SNR for noise suppression purpose, thus minimizing the noise interference on the speech.

According to the above descriptions, the system and method for automobile noise suppression provided in this invention can dynamically change the adjusting parameters for the SNR adjustment according to the automobile speed, thereby suppressing the ambient noise interference in a preferred manner and making the speech clearer. As a result, the disadvantages of the prior art of using only one set of fixed parameters, in which there was improper suppression of the noise and consequent poor speech quality, can be eliminated.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A method for automobile noise suppression in an automobile, comprising:
receiving a voice to generate a voice signal, which includes a speech signal and a noise signal;
determining an adjusting parameter set according to an automobile speed signal corresponding to a speed of the automobile; and
suppressing the noise signal according to the adjusting parameter set.

2. The method as claimed in claim 1, wherein the adjusting parameter set is selected from a group consisting of a noise attenuation slop, a threshold of operating noise attenuation and a maximum noise attenuation level.

3. The method as claimed in claim 1, further comprising a step of:
identifying the speech signal and the noise signal from the voice signal.

4. The method as claimed in claim 1, wherein the step of determining an adjusting parameter set according to an automobile speed signal further comprises:
receiving the automobile speed signal from an odometer through a controller area network bus (CAN bus); and
determining the adjusting parameter set, which is corresponding to the automobile speed signal, by checking a speed-to-parameter lookup table.

5. The method as claimed in claim 1, wherein after the step of suppressing the noise signal, the method further comprises:
generating an adjusted voice signal.

6. The method as claimed in claim 5, further comprising:
transmitting the adjusted voice signal to a radio frequency (RF) module.

7. The method as claimed in claim 5, further comprising:
transmitting the adjusted voice signal to a processor.

8. A system for automobile noise suppression in an automobile, comprising:
a speed sensing device for generating an automobile speed signal;
a processor for receiving the automobile speed signal and determining an adjusting parameter set according to the automobile speed signal; and
a noise suppression device for receiving a voice signal which includes a speech signal and a noise signal, wherein the noise suppression device suppresses the noise signal and generates an adjusted voice signal according to the adjusting parameter set.

9. The noise suppression system as claimed in claim 8, wherein the adjusting parameter set is selected from a group consisting of a noise attenuation slop, a threshold of operating noise attenuation and a maximum noise attenuation level.

10. The noise suppression system as claimed in claim 8, wherein the automobile speed signal is substantially corresponding to a speed of the automobile.

11. The noise suppression system as claimed in claim 10, wherein the processor determines the adjusting parameter set, which is corresponding to the automobile speed signal, by checking a speed-to-parameter lookup table.

12. The noise suppression system as claimed in claim 8, further comprising:
a voice transmitting device for receiving and transmitting the adjusted voice signal.

13. The noise suppression system as claimed in claim 12, wherein the voice transmitting device is a radio frequency (RF) module.

14. The noise suppression system as claimed in claim 8, further comprising a voice receiving device for receiving a voice to generate the voice signal according to the voice, and transmitting the voice signal to the noise suppression device.

15. The noise suppression system as claimed in claim 14, wherein the voice receiving device is a microphone.

16. The noise suppression system as claimed in claim 8, wherein the speed sensing device is an odometer, and the processor receives the automobile speed signal from the odometer through a controller area network bus (CAN bus).

17. The noise suppression system as claimed in claim 8, wherein the adjusted voice signal is transmitted to the processor.
